(19) United States
(12) Patent Application Publication
(10) Pub. No.: US 2007/0076017 A1
(43) Pub. Date: Apr. 5, 2007

(54) ELECTRONIC DEVICE AND IMAGE DISPLAYING METHOD THEREOF

(75) Inventor: SHIH-CHANG HSU, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,691

(22) Filed: Apr. 22, 2006

(30) Foreign Application Priority Data
Sep. 30, 2005 (CN) 200510100114.4

(51) Int. Cl. G09G 5/00

(52) U.S. Cl. 345/649

(57) ABSTRACT

An electronic device (100) includes a system module (110), a display module (131), and a control module (120). The display module is for displaying images of the electronic device. The system module includes an image module (111) for saving the image corresponding to a desired orientation of the image. The control module includes a detecting sub-module (123), a setting sub-module (121), and a display control sub-module (122). The detecting sub-module is for detecting a user request for image orientation adjustment on the electronic device. The setting sub-module is for generating a value, corresponding to the orientation requested by the user according to a detecting result of the detecting sub-module. The display control sub-module is for reading the image, corresponding to the value, from the appropriate image sub-module and providing the image to the display module. An image displaying method employed by the electronic device is also disclosed.

### FIELD OF THE INVENTION

The present invention relates to an electronic device and image displaying method thereof, and particularly to an electronic device and method for displaying an image in different orientations.

### DESCRIPTION OF RELATED ART

Many electronic devices incorporate a display for showing images related to a status of the electronic device on a screen. For example, a set top box will display an image indicating a selected channel, a playing time, and so on, and an ADSL modem will display an image indicating link status. However, should a user like to arrange the electronic device in a position other than its usual orientation in an effort to save space, for example rotating an oblong shaped electronic device by 90 degrees so that it can sit on a narrow end, the image displayed on the screen of the electronic device rotates with the electronic device to the same degree. Thus, it is inconvenient for the user to view the image displayed on the screen.

Therefore, a heretofore unaddressed need exists in the industry to overcome the aforementioned deficiencies and inadequacies.

### SUMMARY OF THE INVENTION

An exemplary embodiment of the invention provides an electronic device. The electronic device includes a system module, a display module, and a control module. The display module is for displaying images of the electronic device. The system module includes an image module for saving an image to be displayed, in an image sub-module corresponding to a desired orientation of the image. The control module includes a detecting sub-module, a setting sub-module, and a display control sub-module. The detecting sub-module is used for detecting a user request for image orientation adjustment on the electronic device. The setting sub-module is used for generating a value, corresponding to the orientation requested by the user according to a detecting result of the detecting sub-module. The display control sub-module is used for reading the image, corresponding to the value, from the appropriate image sub-module and providing the data to the display module.

Another exemplary embodiment of the invention provides an image display method employed by an electronic device. The image display method includes: reading a value; reading an image according to the value, and displaying the image; detecting whether a user requests a new image orientation on the electronic device; if a user request is detected, changing the value; and reading an image according to the changed value, and displaying the image in the corresponding requested orientation.

Other objectives and novel features of the present invention will be drawn from the following detailed description of preferred embodiments of the present invention with the attached drawings, in which:

### BRIEF DESCRIPTION OF THE DRAWINGS

FIG. 1 shows a block diagram of an electronic device of an exemplary embodiment of the invention;

FIG. 2 shows a block diagram of an image-module of an exemplary embodiment of the invention;

FIG. 3 shows orientations of images of a display of the electronic device according to the physical orientation of the electronic device; and

FIG. 4 shows a flowchart of an image display method of an exemplary embodiment of the invention.

### DETAILED DESCRIPTION OF THE INVENTION

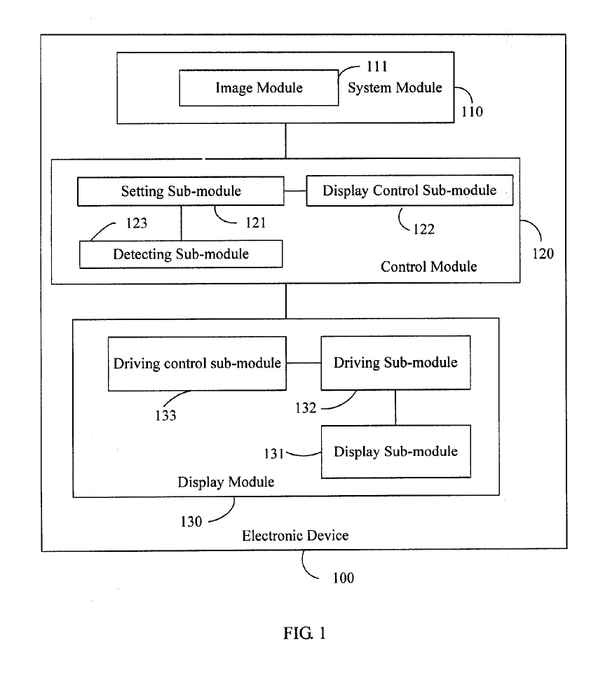

FIG. 1 shows a block diagram of an electronic device 100 of an exemplary embodiment of the invention. The electronic device 100 may be customer premise equipment, such as a set top box or an ADSL modem. The electronic device 100 includes a system module 110, a control module 120, and a display module 130.

The system module 110 includes a transceiver, an encoder, a decoder, and a central processing unit (CPU). When the electronic device 100 is a set top box, the system module 110 is used for sending a connection request, a play request, or a teardown request to a server.

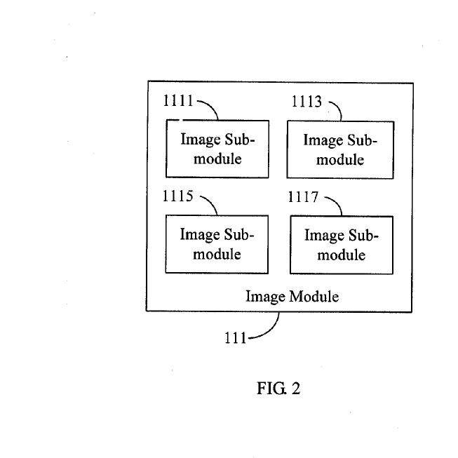

Referring also to FIG. 2, a block diagram of a data-module 111 of an exemplary embodiment of the invention is shown. The system module 110 further includes an image module 111. The image module 111 further includes a plurality of image sub-modules 1111, 1113, 1115, and 1117. The image module 111 is provided for saving images of the electronic device 100. For example, when the electronic device 100 is a set top box, the image module 111 saves images indicating information such as a playing time length or a selected channel. When the electronic device 100 is an ADSL modem, the data module 111 saves images of a link rate with the server, etc.

In the exemplary embodiment, the electronic device 100 may be used in one of four orientations. A first orientation (or position) corresponds to an orientation of the electronic device 100 such that the display and its image is right side up when viewed by a user at power up. A second position corresponds to the electronic device 100 being rotated 90 degrees clockwise (270 degrees counter clockwise) relative to the first position. A third position corresponds to the electronic device 100 being rotated 180 degrees relative to the first position. A fourth position corresponds to the electronic device 100 being rotated 270 degrees clockwise (90 degrees counter clockwise) relative to the first position. Each image sub-module 1111, 1113, 1115, and 1117 corresponds to each of the four positions consecutively. Each image sub-module 1111, 1113, 1115, and 1117 stores a current image of the electronic device 100 along with data for how to display the image according to its corresponding position 1-4. In other embodiments the electronic device 100 can have more or less than 4 positions and corresponding sub-modules.

The control module 120 includes a setting sub-module 121, a display control sub-module 122, and a detecting sub-module 123. The detecting sub-module 123 is used for detecting a user request for changing orientation of the displayed image on the electronic device 100. The setting sub-module 121 is used for generating a value, corresponding to the number of requests received from the user of the electronic device 100, according to a detecting result of the detecting sub-module. The setting sub-module 121 further determines whether the value is over a threshold. The display control sub-module 122 is used for retrieving the data stored in one of the image sub-modules 1111,1113,1115, and 1117, corresponding to the value, from the sub-module 111 and providing the data to the display module 130.

In the exemplary embodiment, five values corresponding to the four positions plus one, are defined with numbers. For example, the first value corresponds to a number “0” which is the first position, the second value corresponds to a number “1” which is the second position, the third value corresponds to a number “2” which is the third position, the fourth value corresponds to a number “3” which is the fourth position, and the fifth value corresponds to a number “4” which is a reset value. In alternative embodiments, the values can be defined with other symbols such as letters. In this embodiment when the electronic device 100 is powered up the initial value will be “0” corresponding with the first position. Subsequently, each time a user request is received the value is incremented by one (in other embodiments the value may be decremented). When the user request is detected by the detecting sub-module 123, the setting sub-module 121 generates a corresponding new incremented value.

In the exemplary embodiment, once the value is incremented, the detecting sub-module 123 detects whether the incremented value is over a threshold of “3”. When the incremented value is over “3”, the setting sub-module 121 resets the value to “0”.

The display control sub-module 122 is used for reading the image from the image module 111, and providing the image to the display module 130. Specifically, the image is read from the one of the image sub-modules 1111, 1113, 1115, 1117 corresponding to the value received from the setting sub-module 123. For example, when the electronic device 100 is powered up, the setting sub-module 121 generates a value of “0”, the display control sub-module 122 receives the value and then reads the image from the image sub-module 1111. Then, if the user request is detected, the value is incremented to “1” by the setting sub-module 121. Therefore, the display control sub-module 122 reads the image from the image sub-module 1113. If the user should decide to reorient the electronic device by 180 degrees from its current orientation then the user would enter two requests (i.e. by pressing a button provided for requests twice) and the value is then incremented twice, which in this scenario would be to “2”, by the setting sub-module 121. Therefore, the display control sub-module 122 reads the image from the image sub-module 1115. If the user should decide to reorient the electronic device by 270 degrees from its current orientation then the user would enter three requests (i.e. by pressing a button provided for requests a third time) and the value is then incremented a third time, which in this scenario would be to “3”, by the setting sub-module 121. Therefore, the display control sub-module 122 reads the image from the image sub-module 1117. If the user request is detected yet again, which would be for a fourth time, the value is now incremented to “4” by the setting sub-module 121. The detecting sub-module 123 finds the value is now over the threshold of 3 and resets the value to “0”, and that is the value passed to the display control sub-module 122. Therefore, the display control sub-module 122 reads the image from the image sub-module 1111.

The display module 130 includes a display sub-module 131, a driving sub-module 132, and a driving control sub-module 133. In the exemplary embodiment, the display sub-module 131 includes a screen, such as an LCD (Liquid Crystal Display) or an LED (Light Emitting Diode) display.

The driving sub-module 132 is used for driving the display sub-module 133. The driving control sub-module 133 is used for generating a control signal for controlling the driving sub-module 132. The driving sub-module 132 corresponds to the display sub-module 131 and the driving control sub-module 133. For example, when the display sub-module 131 is an LCD, the driving sub-module 132 must be an LCD driver. Correspondingly, the driving control sub-module 133 generates a control signal, such as an LCD voltage signal, to control the driving sub-module 132. When the display sub-module 131 is an LED display, the driving sub-module 132 must be an LED driver. Correspondingly, the driving control sub-module 133 generates a control signal, such as a LED voltage signal, to control the driving sub-module 132.

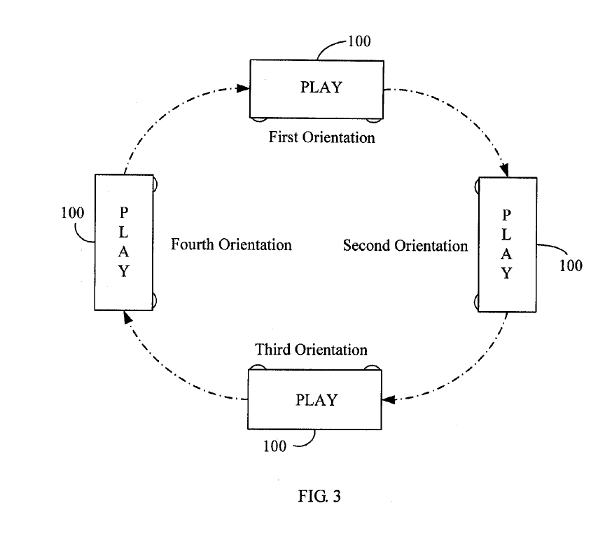

FIG. 3 shows four positions of the exemplary electronic device 100. The electronic device 100 can preferably display the image however the electronic device 100 is placed. Consequently, the user has no inconvenience in reading the image displayed on the electronic device 100.

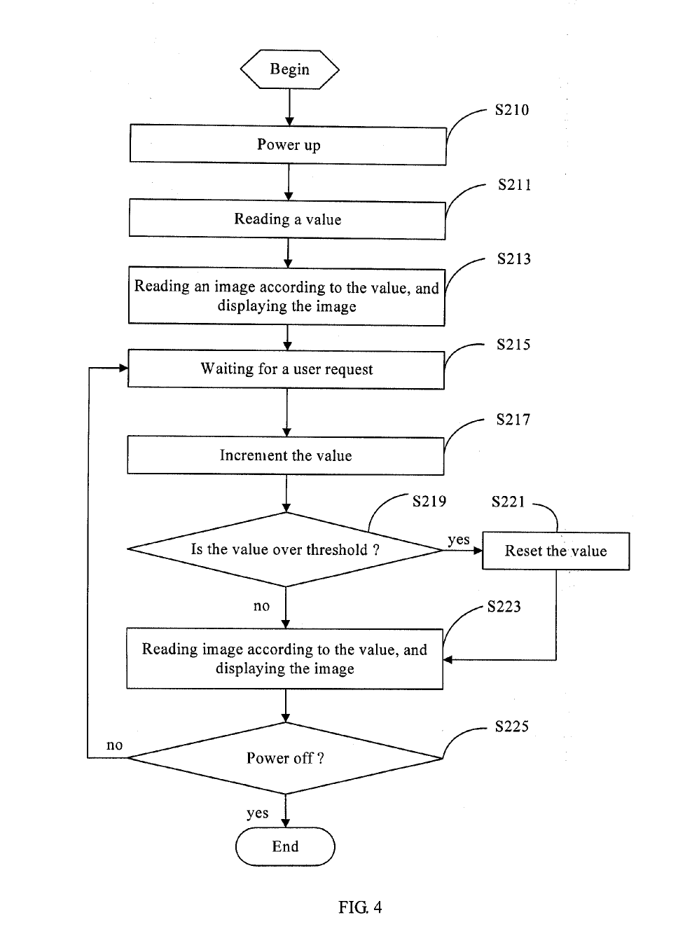

FIG. 4 shows a flowchart of an image display method of an exemplary embodiment of the invention. After the electronic device 100 is powered up in step S210, the display control sub-module 122 reads a value from the setting sub-module 121 in step S211.

In step S213, the display control sub-module 122 reads the image corresponding to the value, and provides the image for the display module 130, and then the display module 130 displays the image read by the display control sub-module 122. For example, when the display control sub-module 122 reads a value, such as the number “0”, in step S211, the display control sub-module 122 reads the image from the image sub-module 1111. Then the display module 130 displays the image on the screen of the electronic device 100.

If and when the user request for image orientation adjustment on the electronic device 100 is detected by the detecting sub-module 123, then the process proceeds to step S215. In step S215, the detecting sub-module 123 waits for the user request for image orientation adjustment on the electronic device 100.

In step S217, the setting sub-module 121 increments the value, then the process proceeds to step S219. In this exemplary embodiment, the value is incremented by the setting sub-module 121. For example, assuming that the value is “0”, after receiving one user request, the value is incremented to “1”. The value will incremented to “2” or “3”, after the user request for image orientation adjustment is received for the second time or the third time. In other exemplary embodiments, the value can also be decremented by the setting sub-module 121.

In step S219, the setting sub-module 121 detects whether the value is over a threshold. If the value is incremented by the setting sub-module 121, the threshold is a maximum value. Then the setting sub-module 121 detects whether the value is over the maximum value. If the value is decremented by the setting sub-module 121, the threshold is a minimum value. Then the setting sub-module 121 detects whether the value is under a minimum value. If the value is over the threshold, the process then proceeds to step S221. If the value is not over the threshold, the process then proceeds to step S223.

In step S221, the setting sub-module 121 resets the value. If the value is incremented by the setting sub-module 121 in step S217, the setting sub-module 121 resets the value to the minimum value. If the value is decremented by the setting sub-module 121 in step S217, the setting sub-module 121 resets the value to the maximum value.

In step S223, the display control sub-module 122 reads the image according to the value, and the display module 130 displays the image read by the display control sub-module 122. For example, if the value is “2”, the display control sub-module 122 reads the image from the image sub-module 1115, and the display module 130 displays the image. Whereas, if the value reaches “4”, counting from the minimum value “0”, the setting sub-module 121 first resets “4” to “0”. Then the display control sub-module 122 reads the image from the image sub-module 1111, and the display module 130 displays the image. If the power is shut off to the electronic device 100 at any time, the process ends, otherwise back to step S215 to wait for another request.

In view of the above, the electronic device 100 according to the exemplary embodiment of the present invention is provided with the display control sub-module 122 and the image sub-module 110, which can the image to be viewed in various orientations.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An electronic device, comprising:
a display module for displaying images of the electronic device; a system module comprising an image module for saving the image of the electronic device to be displayed, in an image sub-module corresponding to a desired orientation of the image;
a control module comprising:
a detecting sub-module for detecting a user request for image orientation adjustment on the electronic device;
a setting sub-module for generating a value, corresponding to the orientation requested by the user according to a detecting result of the detecting sub-module; and
a display control sub-module for reading the image, corresponding to the value, from the appropriate image sub-module and providing the image to the display module.

2. The electronic device as recited in claim 1, wherein the image module comprises a plurality of image sub-modules for saving images of the electronic device.

3. The electronic device as recited in claim 1, wherein the display module comprises a display sub-module for displaying the images read by the displaying control sub-module.

4. The electronic device as recited in claim 3, wherein the display module further comprises a driving sub-module for driving the display sub-module.

5. The electronic device as recited in claim 4, wherein the display module further comprises a driving control sub-module for generating a control signal for controlling the driving sub-module.

6. An image displaying method, employed by an electronic device, comprising:
reading a value;
reading an image according to the value, and displaying the image;
detecting whether a user requests a new image orientation on the electronic device;
if a user request is detected, changing the value; and reading an image according to the changed value, and displaying the image in the corresponding requested orientation.

7. The image displaying method as recited in claim 6, further comprising a step of detecting whether the value is over a threshold.

8. The image displaying method as recited in claim 7, further comprising a step of resetting the value if the value is over a threshold.

9. The image displaying method as recited in claimed 6, wherein the value is incremented by the setting sub-module.

10. The image displaying method as recited in claimed 6, wherein the value is decremented by the setting sub-module.
